(19) United States
(12) Patent Application Publication
(10) Pub. No.: US 2008/0154894 A1
(43) Pub. Date: Jun. 26, 2008

(54) System for cross-acquisition of physiological and psychological information

(75) Inventors: Wu-Fu Chen, Taipei (TW); Hun-Yeu Lai, Taipei (TW)

Correspondence Address: PILLSBURY WINTHROP SHAW PITTMAN, LLP, P.O. BOX 10500, MCLEAN, VA, 22102, US

(73) Assignee: Annlar, Inc., Grand Cayman (KY)

(21) Appl. No.: 11/641,694

(22) Filed: Dec. 20, 2006

(51) Int. Cl. G06F 17/30

(52) U.S. Cl. 707/6; 707/E17.014

(57) ABSTRACT

A system for cross-acquisition of physiological and psychological information includes a test database, a user interface, a database, and a control unit. The test database stores various physiological and psychological questionnaires. The database stores physiological and psychological information inputted by a user or measured by an external apparatus or transmitted thereto from the outside. The control unit includes a matching module capable of accessing the database to perform correlation matching according to a keyword in a question in a selected questionnaire, and an acquisition module for acquiring matching information and for sending the same to the user interface. Through matching and computation, the system can display previously inputted or existing corresponding information when the user comes to a question that has been answered before so as to eliminate the need to repeatedly input the same information.

### BACKGROUND OF THE INVENTION

1. Field of the Invention

The invention relates to a data processing system, more particularly to a system for cross-acquisition processing of physiological and psychological test information.

2. Description of the Related Art

The psychology of humans and psychology-induced human behavior are often influenced by physiological conditions, such as hormonal secretion, pain, etc. On the other hand, psychological conditions, such as depression and excitement, also influence physiological conditions, such as blood pressure, body weight, etc. Therefore, a comprehensive physical examination should include cross-referencing and integrated evaluation of physiological measurement information and psychological assessment.

At present, there are available digital psychological and physiological test and evaluation systems, which primarily allow the user to fill out various psychological questionnaires and physiological information through a human-computer interface. The system will store the inputted data, and will even make a comparison with historical data and safety values, prepare statistics, and provide an output. Thus, the user may be made aware of his/her own physiological and psychological conditions during each test session, and whether they are within the range of safety values. However, the user may have the following problems when using a computerized interface:

1. When doing various psychological and physiological tests, the user often needs to give answers of the same contents repeatedly (e.g., personal data, historical clinical data).

2. In the psychological and physiological tests (such as tests on depression, fatigue, stress index, cardio strength, cardiovascular diseases, asthma, etc.), similar questions may pop up from time to time. However, as the time and place when such questions are asked are different, the user may hesitate and give inconsistent answers.

3. Quantitative physiological parameters (such as body weight, blood pressure value) and qualitative physiological parameters (such as loss of weight, hypertension) may be required to be filled in during psychological tests. A large number of quantitative physiological parameters, such as blood pressure, cholesterol (high density cholesterol, low density cholesterol), body weight, etc., are required to be filled in during physiological tests, such as cardio strength evaluation and cardiovascular disease evaluation. Even all the tests may require filling in of simple clinical data. However, where there is no instrument to provide measurement data as in hospitals, health clinics, or at the spot, the user cannot fill in the correct or latest data.

It is thus apparent that a psychological and physiological test assessment system should provide a user-friendly solution to the above problems.

### SUMMARY OF THE INVENTION

Therefore, the object of the present invention is to provide a system for cross-acquisition of physiological and psychological information, which allows the user to do tests in an easy manner. Accordingly, the system for cross-acquisition of physiological and psychological information of the present invention is constructed on an Internet server for connection thereto by a user, or on an integrated physiological measurement and health assessment apparatus for operation by the user, or on the integrated physiological measurement and health assessment apparatus and a remote administration center for operation by the user through the apparatus.

The system includes a test database, a user interface, at least one database, and a control unit. The test database stores various physiological and psychological questionnaires. The user interface displays questions on any one of the questionnaires in the test database for the user to input answers thereto. When the system is constructed on an Internet server, the user interface is a network interface to enable the user to access the system through the Internet. When the system is constructed on an apparatus, or an apparatus connected to a remote administration center, the user interface is a human-computer interface of the apparatus.

The at least one database stores physiological and psychological information inputted by the user, measured by an external apparatus, or transmitted from the outside, has prearranged data fields, and permits creation of corresponding data fields when a need arises. The fields are classified and constructed as a tier structure, e.g., a three-level structure. Data of the first level are divided into apparatus-measured physiological information, externally inputted physiological information, and psychological questionnaire tests according to sources thereof. Data of the second level are keyword groups derived from each content entry in the first level. Data of the third level are keywords derived from the keyword groups. The at least one database includes a historical information database for storing medical history and accumulated physiological/psychological information, and a real-time operation database for storing measurement information inputted by the user or the integrated physiological measurement and health assessment apparatus or information transmitted from the outside.

The control unit includes a matching module connected to the test database and the at least one database and capable of accessing the at least one database to perform correlation matching according to a keyword in one of the questions, an acquisition module for acquiring matched information and sending the information to the user interface, a classification module, and a computation module. The classification module classifies cross-referenceable information resulting from matching by the matching module into quantitative information and qualitative information. The quantitative information is provided to the computation module for computation. The qualitative information is provided for direct acquisition.

The matching module performs matching according to the following steps:

(A) with respect to the keyword in the question, searching the at least one database for answers or measurement values given to cross-referenceable identical questions, and performing matching by starting from a broad level (the aforesaid first level) and going to narrower levels (i.e., the aforesaid second and third levels);

(B) performing matching and confirmation of the keyword such that cross-referenceable information is obtained, the flow going to step (C) when there is at least one question in the matching result which matches the keyword, the flow going to step (D) when there is no matching question in the matching result;

(C) defining attributes of the cross-referenceable information into directly quotable information and indirectly inferable information, the directly quotable information including information obtained by measurement apparatus or inputted by the user, the indirectly inferable information being based on the directly quotable information and being required to be inferred using a statistical or algorithmic scheme through the computation module in order to be acquirable; and

(D) performing semi-automatic matching to locate possibly relevant information for determination by a system administrator as to whether the same can be considered as cross-referenceable information.

When the cross-referenceable information belongs to quantitative information and is directly quotable, the acquisition module acquires the same from said at least one database for sending to the user interface to be displayed with said one of the questions.

When the cross-referenceable information belongs to quantitative information and requires indirect inference, the computation module acquires the same through the acquisition module for computation and processing using one of statistical, algorithmic and summation schemes and sends the processing result to the user interface to be displayed with said one of the questions.

The acquisition module acquires data according to the following steps:

(i) determining whether cross-referenceable information is stored in said at least one database, the flow proceeding to step (ii) in the affirmative and the flow is ended if otherwise;

(ii) performing screening of effective times of data such that only qualitative data that are within a defined effective time limit are considered as effective and acquirable data; and

(iii) determining whether the cross-referenceable data are a single entry of data or multiple entries of data, the acquisition module performing acquisition if the cross-referenceable data are a single entry of data, the acquisition module performing a frequency analysis of multiple results to the same question, and acquiring only those matching results with a higher frequency.

### BRIEF DESCRIPTION OF THE DRAWINGS

Other features and advantages of the present invention will become apparent in the following detailed description of the preferred embodiment with reference to the accompanying drawings of which:

FIG. 1 is a block diagram to illustrate a preferred embodiment of a system for cross-acquisition of physiological and psychological information according to the present invention;

FIG. 2 is a diagram to illustrate the structure of a database of the preferred embodiment;

FIG. 3 is a flowchart to illustrate the operation of a matching module of the preferred embodiment; and

FIG. 4 is a flowchart to illustrate the operation of an acquisition module acquiring information from a database.

### DETAILED DESCRIPTION OF THE PREFERRED EMBODIMENT

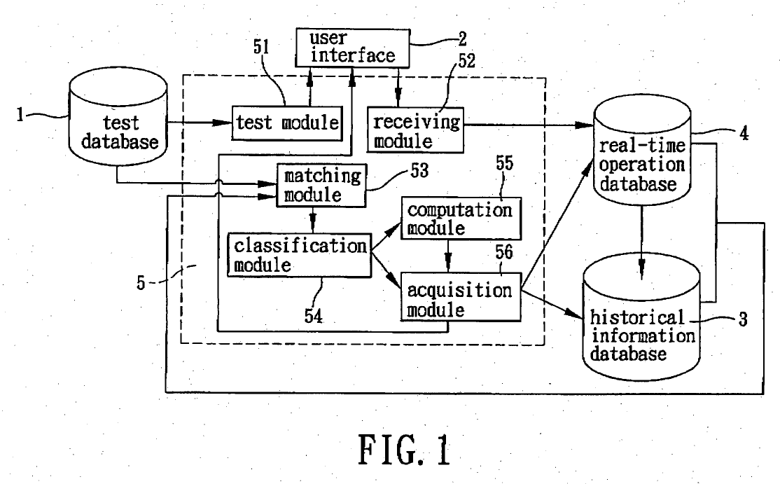

Referring to FIG. 1, a system for cross-acquisition of physiological and psychological information according to this invention may be constructed on an Internet server for connection thereto by a user, or on an integrated physiological measurement and health assessment apparatus (not shown) for operation by the user, or on the integrated physiological measurement and health assessment apparatus and a remote administration center (not shown) for operation by the user through the apparatus. The preferred embodiment will be exemplified using the latter as an example, but should not be limited thereto.

The system 100 includes a test database 1 for storing various questionnaires a user interface 2 to display test contents and information and to allow input by the user, a historical information database 3 for storing medical history and accumulated physiological/psychological information, a real-time operation database 4 for temporary storage of measurement information inputted by the user or from the integrated physiological measurement and health assessment apparatus or of information sent from the outside, and a control unit 5 connected to the test database 1, the user interface 2, the historical information database 3, and the real-time operation database 4. In this embodiment, the test database 1, the historical information database 3, the real-time operation database 4, and the control unit 5 are provided at the remote administration center for administration and operation by a system administrator, whereas the user interface 2 is disposed at the integrated physiological measurement and health assessment apparatus.

In this embodiment, the amount and contents of the questionnaires stored in the test database 1 can be expanded, and the questionnaires include physiological electronic questionnaires on, e.g., migraine, hereditary hair loss, cardiovascular diseases, allergy-induced nasal infection, asthma, breast cancer, cardio strength, and male/female menopause, and psychological electronic questionnaires on, e.g., depression, degree of stress, degree of fatigue, senile dementia, erectile dysfunction, and simplified suicide evaluation. These questionnaires allow the user to answer the questions one by one through the user interface 2.

As the physiological and psychological data of an individual need to be assessed and evaluated on a long-term basis in order to be able to understand the tendency and changes in the physiological and psychological conditions of the individual, the historical data in the real-time operation database 4 are transferred to the historical information database 3 for storage after rearrangement of data fields and checking. The historical data referred to herein are defined as physiological and psychological data that have been stored in the real-time operation database 4 for over a specific length of time (e.g., for a number of, weeks or months, as defined by the system administrator).

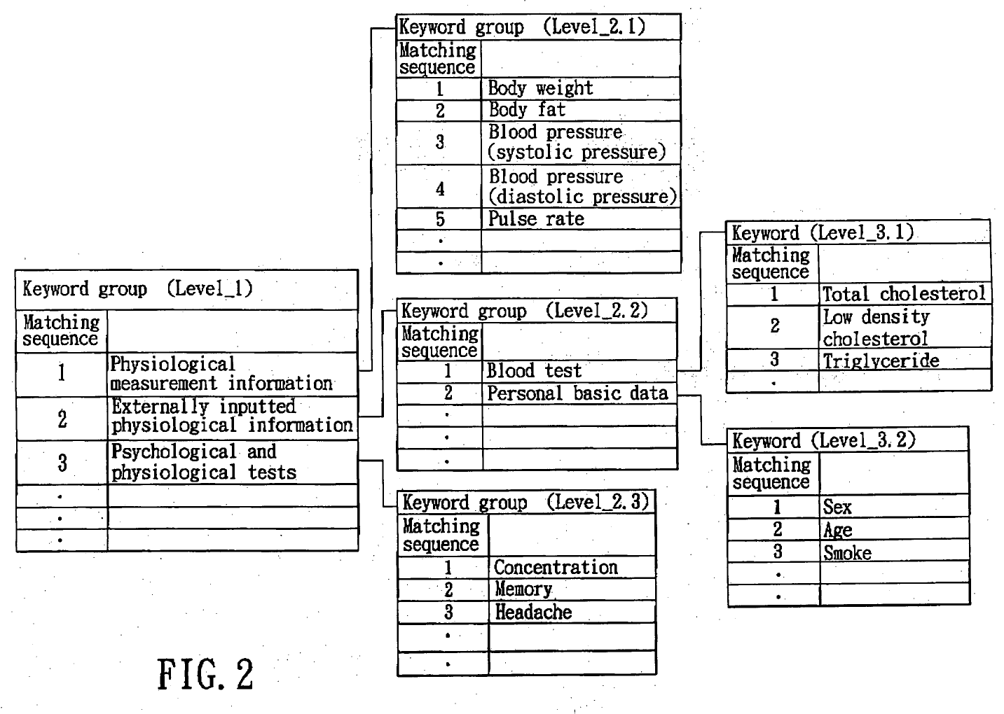

The construction of the data structure of the historical information database 3 and the real-time operation database 4 is to plan the data fields in advance, and to allow the creation of corresponding data fields when a need arises (e.g., when creating a new questionnaire file). The fields may be classified according to the definitions of the system administrator, and data relationships are constructed. The embodiment is constructed as a tier structure such as that shown in FIG. 2, which includes three levels. Data of the first level are apparatus-measured physiological information, externally inputted physiological information, tests according to psychological questionnaires, etc., which are classified by sources thereof. The second level includes keyword groups derived from each content entry in the first level. For example, externally inputted physiological information includes keyword groups of blood test, personal basic data, etc. The third level includes keywords derived from each keyword group. For example, the keyword group of blood test includes total cholesterol, low density/high density cholesterol, triglyceride, etc. The number of levels of the structure is not limited, and the structure can be infinitely expanded.

The control unit 5 includes a test module 51 capable of accessing the questionnaires in the test database 1 and sending the questions thereon one by one to the user interface 2 for display, and a receiving module 52 for receiving information inputted by the user for storage in the real-time operation database 4. Most importantly, in order that the user does not have to answer the same or similar questions on the questionnaires again and again, the control unit 5 of the present invention further includes a matching module 53, a classification module 54, a computation module 55, and an acquisition module 56 for executing information determination and information cross-acquisition functionality.

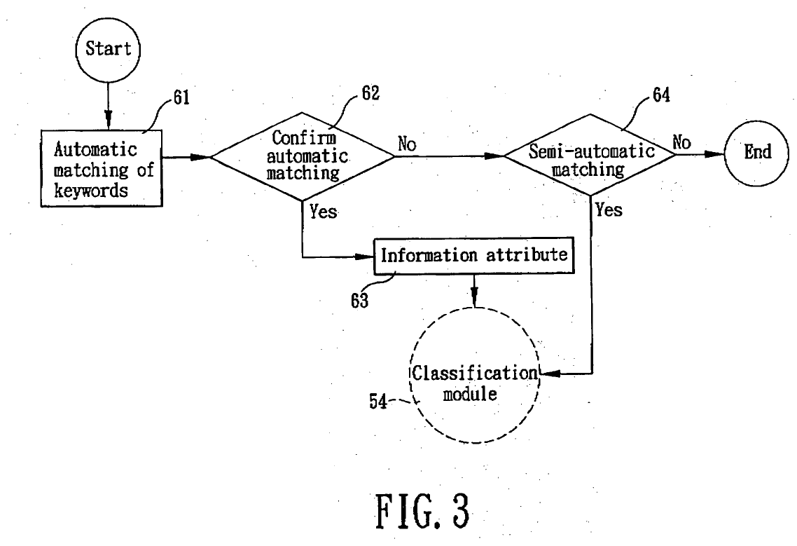

The matching module 53 is connected to the test database 1 and the historical information database 3 and the real-time operation database 4. In this embodiment, the matching module 53 can automatically perform a pre-matching when a new questionnaire (e.g., a depression questionnaire) is to be created in the test database 1, and can directly catch matching data when the user is ready to answer the questions on the questionnaire. Not limited to the above, the matching module 53 of this invention may alternatively perform matching when the user is ready to do the test in the new questionnaire. The method of matching adopted by the matching module 53 is to automatically search keywords or key phrases in the questions on the new questionnaire, e.g., “weight loss” in one of the questions, and to subsequently proceed with the flow shown in FIG. 3 (as described below) so as to conduct cross-referencing and matching of correlations of the questions in various psychological and physiological questionnaires currently stored in the historical information database 3 and the real-time operation database 4:

Step 61: Automatic matching of keywords. With respect to the target keyword in the new questionnaire, the matching module 53 searches the historical information database 3 and the real-time operation database 4 for answers or measurement values provided to cross-referenceable identical questions, starting from the keyword groups in the first level, and going to the keyword groups in the second level and further to the keywords in the third level for matching purposes.

Step 62: Confirmation of keyword matches. If there is one or more than one question matching the keyword in the matching result in step 61, e.g., several entries of weight information that were measured or inputted during different sessions, a match is confirmed. That is, cross-referenceable information is located. The flow then goes to step 63. If there is no matching question, the flow goes to step 64.

Step 63: Defining attributes of “cross-referenceable information.” The cross-referenceable information in this embodiment is divided into directly quotable information and indirectly inferable information.

Information that can be directly quoted includes data measured using a measuring instrument or data inputted by the user, e.g., blood pressure, body weight, whether there is a frequent urination condition, etc.

Information that needs to be indirectly inferred is based on the directly quotable information and can be acquired by inference using statistics or algorithms, e.g., whether there is a weight loss. Such information needs to undergo subtraction processing by the computation module 55 after indirect inference in order to be acquirable.

The matching is completed after this step. Then, the classification module 54 performs processing of the cross-referenceable information.

Step 64: Semi-automatic matching. When a correct corresponding matching question cannot be found during keyword matching, possibly related information is located for the system administrator to determine whether there is a match. For example, if there is a question “I do not sleep well” on the new questionnaire, and there are two questions “Have the feeling of not getting enough sleep” and “Difficulty falling asleep or light and disturbed sleep” on an existing fatigue questionnaire, and two other questions “Having trouble falling asleep or is often unable to sleep tight,” “Occasionally waking up at 1:00 a.m. or 2:00 a.m. and unable to go back to sleep” on a stress questionnaire, these four questions can be listed as matching information.

Take another questionnaire as an example, in which the new questionnaire is a “cardio strength evaluation,” and there is one question “are you under treatment of blood pressure reducing drugs?” thereon. If a matching question cannot be found from a data source of apparatus-measured physiological information during the automatic matching of keywords, the other data source, i.e., the externally inputted physiological data, is accessed to locate questions related to “use of blood pressure reducing drugs” for cross reference.

If the semi-automatic matching in step 64 is completed, the classification module 54 will likewise perform processing of the cross-referenceable information. If the semi-automatic matching yields no result, the matching is ended, indicating that the system does not have any relevant information of answers that the user had ever given, and that the user had never inputted any relevant information usable for cross-referencing. Thus, the test module 1 will merely show the above question itself.

Referring once again to FIG. 1, in this embodiment, the cross-referenceable information for which matching was completed by the matching module 53 needs to be further classified by the classification module 54 so as to facilitate subsequent calculation and data acquisition. The classification module 54 classifies information into four types, namely, physiological quantitative information (including body weight, pulse rate, body fat, blood pressure, cholesterol, etc., or inferred body mass index (BMI) value, atherosclerosis index value, mortality rate), psychological quantitative information (such as scores from the various questionnaires and evaluations), physiological qualitative information (such as the user is or is not a smoker, sleep quality, sore muscles, appetite, etc.), and psychological qualitative information (such as concentration, sexual function, memory, etc.).

When the cross-referenceable information belongs to physiological or psychological quantitative information, the computation module 55 performs the required computation according to the attributes defined by the matching module 53 in step 63. For information that needs to be inferred indirectly, the information is acquired through the acquisition module 56, and is then computed and processed using one of statistical, algorithmic, and summation schemes. The result is sent to the user interface 2 for display. Statistical schemes include mean values, smallest values, largest values, median values, standard differences, or levels decided using determining equations. Algorithmic schemes include BMI value calculation, atherosclerosis index calculation, etc. Summation schemes include calculation of age, etc.

When the cross-referenceable information belongs to physiological or psychological quantitative information that can be directly quoted, e.g., a one-time measurement value (body weight, body fat percentage, pulse rate, etc.) or a measurement value at a single point of time (e.g., the most recently measured body weight, blood pressure, total cholesterol, etc.), the acquisition module 56 will go to specific fields of the historical information database 3 and the real-time operation database 4 to acquire the information and send the same to the user interface 2 for display. In addition, the priority of acquisition of data in the real-time operation database 4 is higher than that of the historical information database 3.

If the cross-referenceable information belongs to physiological or psychological qualitative data, there is no need to go through the computation module 55. The acquisition module 56 will directly perform data acquisition instead.

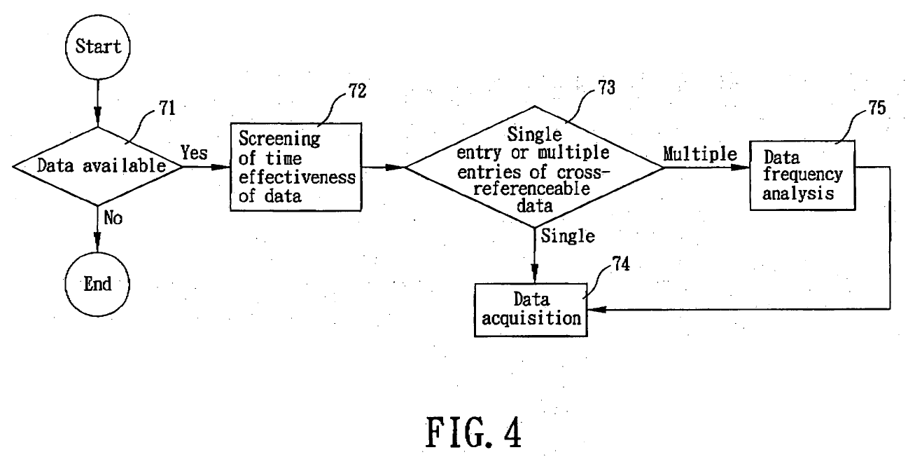

Referring to FIG. 4, the acquisition module 56 of this embodiment acquires data according to the following steps:

In step 71, it is determined whether cross-referenceable information is stored in the historical information database 3 and the real-time operation database 4. If yes, step 72 is carried out. Otherwise, the acquisition flow is ended.

In step 72, screening of effective time of the data is performed. The effective time of qualitative data can be defined by the system administrator. For instance, data obtained within one year as stored in the historical information database 3 and the real-time operation database 4 can be defined as effective and acquirable data.

In step 73, it is determined whether the cross-referenceable data are a single entry of data or multiple entries of data. If the cross-referenceable data are a single entry of data, step 74 is carried out, in which the acquisition module 56 performs data acquisition. If the data are multiple entries of data, step 75 is carried out, in which the acquisition module 56 performs a frequency analysis of multiple results to the same questions. Only those matching results with a higher frequency will be acquired.

To cite a concrete example, when the user does a cardio strength evaluation questionnaire which includes the keywords “total cholesterol” in one of the questions, before the test module 51 of the control unit 5 sends out the question, the matching module 53 can perform a matching quickly and automatically to locate cross-referenceable data, confirm the data (steps 61, 62), and define the attributes (step 63) since the matching module 53 already performed a matching beforehand. Then, the classification module 54 classifies the cross-referenceable information into physiological quantitative information, and the computation module 55 acquires single-value information from the historical information database 3 and the real-time operation database 4 through the acquisition module 56.

Take another example. When the user does a stress questionnaire with the question “Having trouble falling asleep or is often unable to sleep tight,” before the test module 51 of the control unit 5 sends out the question, the matching module 53 can quickly perform the automatic matching step (step 61) and the confirmation step (step 62), and proceed with the semi-automatic matching flow (step 63) since the matching module 53 already performed matching beforehand. Then, the classification module 54 classifies the cross-referenceable information into “psychological qualitative information.” Subsequently, the acquisition module 56 goes directly to the historical information database 3 and the real-time operation database 4 to acquire the information according to steps 71 to 74. Thus, since the user left a record related to that question in the system 100, the record will be sent to the user interface 2 and displayed together with the question.

In sum, the system of the present invention provides user-friendly services with respect to digital physiological or psychological questionnaires and evaluations. Through information matching and computation, cross-referenceable information can be located such that the system is able to display the relevant cross-referenceable information when the user comes to a question that he/she has once answered, so that the user does not need to input the answer once again or the user can answer the question with reference to the answer he/she has given before.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A system for cross-acquisition of physiological and psychological information, comprising:
a test database for storing various physiological and psychological questionnaires;
a user interface for displaying questions on any one of the questionnaires for a user to input answers thereto;
at least one database for storing physiological and psychological information; and
a control unit including a matching module connected to said test database and said at least one database and capable of accessing said at least one database to perform correlation matching according to a keyword in one of the questions, and an acquisition module for acquiring the matching information and for sending the matching information to said user interface.

2. The system for cross-acquisition of physiological and psychological information according to claim 1, wherein said control unit further includes a classification module and a computation module, said classification module classifying cross-referenceable information resulting from matching by said matching module into quantitative information and qualitative information, the quantitative information being provided to said computation module for computation, the matching information being acquired by said acquisition module from said at least one database according to one of computation result from said computation module and the qualitative information from said classification module.

3. The system for cross-acquisition of physiological and psychological information according to claim 1, wherein said matching module performs matching according to the following steps;
(A) with respect to the keyword in one of the questions, searching said at least one database for answers or measurement values previously given to cross-referenceable identical questions;
(B) performing matching and confirmation of the keyword such that cross-referenceable information is obtained, the flow going to step (C) when there is at least one question in the matching result which matches the keyword, the flow going to step (D) when there is no matching question in the matching result;
(C) defining attributes of the cross-referenceable information into directly quotable information and indirectly inferable information; and
(D) performing semi-automatic matching to locate possibly relevant information for determination by a system administrator as to whether the possibly relevant information can be considered as cross-referenceable information.

4. The system for cross-acquisition of physiological and psychological information according to claim 3, wherein said control unit further includes a computation module, the directly quotable information in step (C) including information obtained by a measurement apparatus and information inputted by the user, the indirectly inferable information being based on the directly quotable information and being required to be inferred using one of statistical and algorithmic schemes through said computation module in order to be acquirable.

5. The system for cross-acquisition of physiological and psychological information according to claim 4, wherein said control unit further includes a classification module for classifying the cross-referenceable information resulting from matching by said matching module into quantitative information and qualitative information, said acquisition module acquiring the cross-referenceable information that is classified as quantitative information and that is directly quotable from said at least one database for sending to said user interface to be displayed with said one of the questions.

6. The system for cross-acquisition of physiological and psychological information according to claim 4, wherein said control unit further includes a classification module for classifying the cross-referenceable information resulting from matching by said matching module into quantitative information and qualitative information, said computation module acquiring the cross-referenceable information that is classified as quantitative information and that requires indirect inference through said acquisition module for computation and processing using one of statistical, algorithmic and summation schemes, processing result of said computation module being sent to said user interface for display with said one of the questions.

7. The system for cross-acquisition of physiological and psychological information according to claim 3, wherein said at least one database is constructed as a tier structure.

8. The system for cross-acquisition of physiological and psychological information according to claim 7, wherein the tier structure of said at least one database includes first, second and third levels, data of the first level being divided into apparatus-measured physiological information, externally inputted psychological information, and psychological questionnaire test according to sources thereof, data of the second level being keyword groups derived from each content entry in the first level, data of the third level being keywords derived from each of the keyword groups in the second level.

9. The system for cross-acquisition of physiological and psychological information according to claim 3, wherein said matching module automatically performs a pre-matching when a new questionnaire is to be created in said test database, and directly captures matching data from said at least one database when the new questionnaire is retrieved for testing.

10. The system for cross-acquisition of physiological and psychological information according to claim 3, wherein said matching module performs matching only when a new questionnaire is retrieved for testing.

11. The system for cross-acquisition of physiological and psychological information according to claim 1, wherein said at least one database is constructed with pre-arranged data fields, and permits creation of corresponding data fields when a need arises, the fields being classified and constructed as a tier structure.

12. The system for cross-acquisition of physiological and psychological information according to claim 1, wherein said at least one database includes a historical information database for storing medical history and accumulated physiological/psychological information, and a real-time operation database for temporarily storing measurement information inputted by the user or from an integrated physiological measurement and health assessment apparatus, or information transmitted from the outside.

13. The system for cross-acquisition of physiological and psychological information according to claim 12, wherein said real-time operation database is operable to transfer physiological and psychological data which have been stored therein for a time exceeding a defined specific length of time to said historical information database for storage.

14. The system for cross-acquisition of physiological and psychological information according to claim 12, wherein said acquisition module acquires data according to priority, the data in said real-time operation database having an acquisition priority higher than that of the data in said historical information database.

15. The system for cross-acquisition of physiological and psychological information according to claim 1, wherein said acquisition module acquires data according to the following steps:
(i) determining whether cross-referenceable information is stored in said at least one database, the flow proceeding to step (ii) in the affirmative and the flow is ended if otherwise;
(ii) performing screening of effective times of data such that only qualitative data that are within a defined effective time limit are considered as effective and acquirable data; and
(iii) determining whether the cross-referenceable data are a single entry of data or multiple entries of data, said acquisition module performing acquisition if the cross-referenceable data are a single entry of data, said acquisition module performing a frequency analysis of multiple results to the same question, and acquiring only those matching results with a higher frequency.

16. The system for cross-acquisition of physiological and psychological information according to claim 1, wherein the questionnaires stored in said test database are expandable in number and content, and include physiological and psychological electronic questionnaires.

17. The system for cross-acquisition of physiological and psychological information according to claim 1, wherein said system is adapted to be constructed on one of an Internet server for connection thereto by the user, an integrated physiological measurement and health assessment apparatus for operation by the user, and the integrated physiological measurement and health assessment apparatus connected to a remote administration center for operation by the user through the apparatus.

18. The system for cross-acquisition of physiological and psychological information according to claim 1, wherein said control unit further includes a test module capable of accessing the questionnaires in said test database and sending the questions on each of the questionnaires one by one to said user interface for display, and a receiving module for receiving information inputted by the user and for storing the information in said at least one database.
